(19) United States
(12) Patent Application Publication
(10) Pub. No.: US 2024/0409047 A1
(43) Pub. Date: Dec. 12, 2024

(54) DYNAMIC ADAPTATATION OF VEHICLE FEATURES AND SETTINGS FOR A DRIVER

(71) Applicant: FORD GLOBAL TECHNOLOGIES, LLC, Dearborn, MI (US)

(72) Inventors: Gitanjli MCROY, Ann Arbor, MI (US); Patrick Soderborg, Dexter, MI (US)

(21) Appl. No.: 18/332,986

(22) Filed: Jun. 12, 2023

(51) Int. Cl. B60R 16/037; B60K 35/00

(52) U.S. Cl. CPC B60R 16/037; B60K 35/00; B60K 35/22; B60K 35/28; B60K 35/654; B60K 2360/176; B60K 2360/33

(57) ABSTRACT

A vehicle enacts a change to a feature setting affecting vehicle performance and stores an association between a driver of the vehicle and the change. The vehicle monitors performance with respect to the at least one aspect following enactment of the change and reports the vehicle performance. The vehicle issues an inquiry with predefined questions enquiring about the driver's changed experience in light of the change. Responsive to the driver's answers, the vehicle determines whether a second change should be made to the vehicle feature setting and the nature of the second change. The vehicle enacts the second change and repeats the monitoring, reporting, inquiry, determination of whether to make and the nature of additional changes subsequent to the second change, and enactment of the additional changes, until there is a determination that no additional changes should be made, to tune the vehicle feature setting to the driver.

### TECHNICAL FIELD

The illustrative embodiments generally relate to systems and methods for dynamic adaptation of vehicle features and settings for and to accommodate a given driver.

### BACKGROUND

Vehicles continue to improve in reactivity, adaptability, variety of features available and driver-customization options. This increased complexity often leads to drivers simply not using certain features or not tuning certain settings because they do not know about the feature or setting, do not understand how to tune the feature or setting, or do not understand how changing the feature or setting will affect their experience. The driver further may not understand how their personal driving style could benefit from, or be affected by, a change to a certain setting or tuning of a certain feature. Many drivers may not even be capable of defining their personal driving style sufficiently to know how to classify their own style, even if told which settings were good for use with which styles.

### SUMMARY

In a first illustrative embodiment, a vehicle includes one or more processors configured to enact a first change to a vehicle feature setting affecting vehicle performance in at least one aspect and store an association between a determined driver of the vehicle and the change. The one or more processors are further configured to monitor vehicle performance with respect to the at least one aspect for at least a predetermined period following enactment of the change and report, using a vehicle display, the vehicle performance with respect to the at least one aspect following the monitoring. The one or more processors are also configured to, responsive to the reporting, issue an inquiry with one or more predefined questions enquiring about the driver's changed experience in light of the change, the questions predefined for at least the at least one aspect and determine whether a second change, responsive to the driver's answers to the inquiry, should be made to the vehicle feature setting, based on the driver's answers. Also, the one or more processors are configured to, responsive to determining that the second change should be made, determine the nature of the second change and enact the second change responsive to determining the nature of the second change. The one or more processors are additionally configured to repeat the monitoring, reporting, inquiry, determination of whether to make and the nature of additional changes subsequent to the second change, and enactment of the additional changes until there is a determination that no additional changes should be made, to tune the vehicle feature setting to the driver.

In a second illustrative embodiment, a vehicle includes one or more processors configured to access a predefined social media account of a determine driver and obtain at least one of a plurality of pictures or text postings saved by the driver on the social media account. The one or more processors are configured to analyze the obtained pictures or text postings to determine at least one predicted driver preference and automatically adjust at least one vehicle feature setting in a manner predefined for at least one determined preference.

In a third illustrative embodiment, a vehicle includes one or more cameras capable of viewing a driver of the vehicle and one or more processors in communication with the one or more cameras. The one or more processors are configured to image the driver using at least one of the one or more cameras and determine, based on the imaging, at least one color associated with an outfit of the driver. The one or more processors are additionally configured to automatically adjust at least one of vehicle color changeable interior or exterior lighting or a vehicle display characteristic to include the at least one color.

### BRIEF DESCRIPTION OF THE DRAWINGS

FIG. 1 shows an illustrative vehicle adaptation system including various illustrative inputs and sources of information;

FIG. 2 shows an illustrative adaptation process leveraging driver data;

FIG. 3 shows one example of a particular illustrative adaptation;

FIG. 4 shows an additional example of a particular illustrative adaptation;

FIG. 5 shows an example of post-driving adaptive tuning;

FIG. 6A shows an example of a menu for selective tuning instruction;

FIG. 6B shows an illustrative process for selective tuning; and

FIG. 7 shows an illustrative process for coaching and behavior tuning.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments leverage a variety of possible inputs—ranging from social media, to occupancy characteristics, to observed driving tendencies, for example—to create an ongoing evolving user vehicle experience. An adaptive vehicle process can analyze a variety of driver related inputs to better anything from vehicle aesthetics to driving/ride style, customized for a specific driver or family and continually learning from input analysis, if desired. Not only does this create a better overall vehicle usage experience, but automatically implementing certain vehicle control features reactive to driving style, such as adjustments to ride height, suspension tuning, pedal actuation and other complex vehicle features can increase overall vehicle efficiency.

Drivers may have difficulty understanding the available options and controls on modern vehicles, and how tuning and changing those controls affects the overall vehicle experience, let alone how the options and controls affect the experience with regards to their own personal driving tendencies. Even in simplistic situations a driver may be unaware of a useful feature—e.g., a driver may always turn the air conditioning to maximum on a hot day or the heat to maximum on a cold day without realizing that there are vehicle preconditioning settings that can be engaged that will, sometimes even predictively, achieve a preferred cabin temperature before a ride even begins. Then, instead of having to ride in discomfort for a number of minutes waiting for cabin temperature to normalize, and often experiencing an overcorrection, the driver can find a vehicle frequently waiting at a preferred temperature upon arrival.

Other drivers may be very stylistically oriented, and may be unaware that they can tune vehicle interior and exterior lighting to suit color preferences. Vehicle sounds may be modified to suit a driver's style and moods.

More complex vehicle features, such as pedal resistance, suspension, ride height, etc. may also be adjusted for a different driving experience, but a driver unfamiliar with such tuning may be hesitant to make such adjustments, if they even know such adjustments are possible. Not only may they lack the knowledge of what the adjustment will actually change, but they may not have sufficient appreciation of the usefulness of one adjustment versus another when it comes to their personal driving style. This can lead to fuel inefficiencies in acceleration and regenerative braking. as well as other vehicle usage that could be better tuned a driver's personal style.

The illustrative embodiments allow for a vehicle or vehicle-related process to determine likely preferred settings for many features, including making the more complex adjustments to better suit an observed driving style. This increases user satisfaction with a vehicle experience, and allows increased usage of the many features of modern vehicles. Additionally, in many instances, this can increase vehicle efficiency and can potentially decrease maintenance required due to, for example, a vehicle configured for a certain type of driver being used by one exhibiting a different style.

The illustrative embodiments, and the like, can leverage driver data obtained from feedback, surveys, social media, observation during use, etc. to identify likely driver preferences and trends. This information can be used in conjunction with vehicle-centric options that can be adjusted to recommend and/or implement a combination of parameter settings and feature usage that aligns with a particular driver.

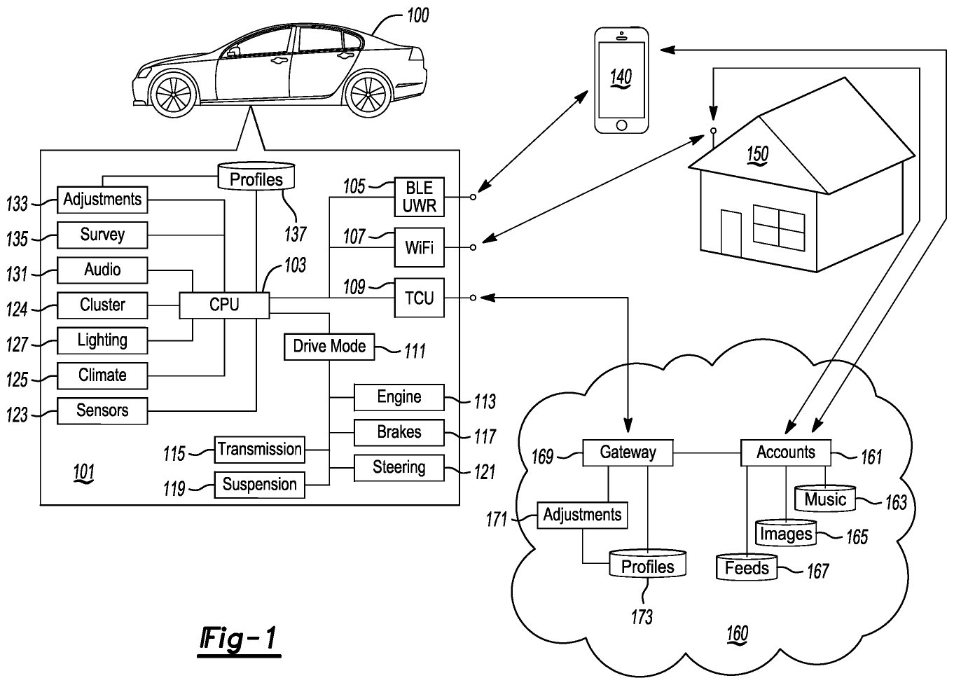

FIG. 1 shows an illustrative vehicle adaptation system including various illustrative inputs and sources of information. In this example, the vehicle 100 may include an onboard computing system 101 comprising, among other things, one or more processors 103 as well as a wide variety of software, firmware, memories, electronic control units (ECUs) and vehicle system controls.

Wireless vehicle communication may be enabled by one or more transceivers such as, for example, BLUETOOTH low energy (BLE) and/or ultrawideband (UWB) transceiver 105, usable for shorter range communication with nearby devices such as a use device 140. Wi-Fi transceiver 107 may be able to communicate with infrastructure access points (APs), other vehicles and home 150 access points. This allows for the vehicle to use, for example, a home network to obtain user data while the user is away from a vehicle, minimizing power and data usage as well as leveraging the user's own highspeed networks.

A telematics control unit (TCU) can provide a cellular communication option to the cloud 160, which can include a manufacturer backend controlled by a gateway 169 as well as a variety of user accounts 161 accessible through a connection to the internet in general. Data from the home network, devices, and the cloud can be used by the vehicle computing system 101 in an adjustments process 133, a version of which 171 may also reside in the cloud at the manufacturer backend. This way, cloud computing and updated understanding of applicability of configurations can be integrated into the process in a seamless manner.

The adjustments process 133 may be able to leverage user data to control, among other things, drive modes 111, which can include engine settings 113, transmission settings 115, brake settings 117, suspension settings 119, steering settings 121. Other controllable systems may include, for example, without limitation, vehicle sensors 123, such as camera views and engagement, climate settings 125, lighting settings 127, both for interior and exterior lighting, cluster display 129, audio outputs 131.

A more detailed, but still not exhaustive, list of controllable vehicle settings includes: accelerator pedal progression calibration, tip in/out calibration, acceleration rate for adaptive cruise control, decel fuel shutoff enabled by mode, overboost disablement for eco mode, reduced turbo lag, better noise, vibration and harshness (NVH) on backout, stop/start controls for engines, downshift revmatching, electronic limited slip differential (eLSD) calibration, shift schedule calibration, top gear reduction, curve upshift calibration, backout inhibit calibration, grade braking downshift calibration, alternate shift indication for eco mode, manual shift mode engagement, blower speeds, charge session and depletion session settings, exhaust sounds, antilock braking system (ABS) calibration, brake pedal feel, lift pedal regeneration, electronic stability control (ESC) calibration, traction control calibration, brake pedal tuning, steer feel calibration, damping calibration, spring rates, ride height, sway bar disconnect, all wheel drive mode calibration, e-locker calibration, adaptive cruise control gap calibration, message suppression calibration, maximum acceleration-saturation calibration, camera view activation, ambient vehicle lighting colors, active noise cancellation, sound profile configuration, drive mode displays for clusters, colors and backgrounds for clusters, adaptive cruise control lead vehicle indicator location, seat positions, steering wheel positions, steering wheel resistance tuning, steering ratio tuning, active exhaust calibration, heating/venting of seats, mirror positions, speed adaptive sound volume, synthetic powertrain noise settings, chimes, sounds, temperatures, air outputs, etc.

It should be apparent that it may be virtually impossible for a sophisticated user, let alone an average user, to accurately understand and control all these settings to optimize a driving experience or tune an experience for a vehicle, especially an unfamiliar vehicle, to that driver's personal style. And yet, because the vehicle has complex understanding of the effects of various tunings and usages, it can quickly and accurately utilize or recommend many setting changes that may have the net effect of greatly increasing driver satisfaction and comfort with the vehicle. Moreover, if a driver's habits change, the vehicle can adapt to the changing habits and keep the vehicle running in a state that is suited for the changing driver habits. This may be especially useful for younger drivers, who may not yet have a driving style, and as they get more comfortable driving the vehicle can grow with their driving habits to match their style and preferences.

Surveys 135, presented at purchase, after drives, after feature usage or changes, and/or periodically as a user permits, can gather active input from a driver to allow the system to better understand how the driver feels about a given change or accommodation. This also increases the ability of the system to better predict what changes may be better received by the driver in the future—e.g., if the driver always wants suspension changes to revert to a base state, at some point the system may stop offering suspension changes. User profiles 137 can store user preferred data and applied settings, as well as historical data from vehicle observations about preferences and habits, to keep any machine learning system well educated about the user it is serving. Copies of the profiles 173 may also be stored in the cloud to allow remote processes such as the remote adjustments process 171 to suggest or recommend changes.

Aesthetic, stylistic and personality preferences may be discernable from user social accounts 161, which may store or indicate color preferences, music preferences 163, images 165 (from which much can be discerned), and user comments and feeds 167. Analysis of music, feeds, images, etc. can reveal user personality traits, sports team preferences, color preferences, music preferences, etc. For example, a user who is a fan of a sports team based on countless images and commentary may enjoy having the vehicle changed to ambient team colors on game days, as well as having the radio automatically tune to whatever station is broadcasting the game (if available) whenever the vehicle is started on a game day and/or during the game. Feedback could also provide the same intelligence—if a user was often in a known college city on Saturdays during football games and always tuned the radio to the sports station covering the game whenever the vehicle was started before the game ended, this information could be used to automatically make assumptions about the fact that the user was probably attending a certain football game.

In other instances, the vehicle may have a complete preset package (any of which can be changed or undone by a driver) that is engaged responsive to the answer to a simple question. For example, a driver could be asked if they prefer smooth/luxurious or a sporty/firm ride. If the driver selected sporty or firm, the vehicle could, for example, tighten suspension, lower ride height, increase steering resistance, increase or simulate powertrain sounds, manipulate audio to energetic stations, change interior lighting to red, switch an HMI to a race theme, change vehicle chimes to race related chimes, map pedals to aggressive braking and acceleration, and change shift points to later shifts to hold gears longer. If the user answered luxurious/smooth, the vehicle could, for example, loosen suspension, increase ride height, increase noise cancelling, soften interior lighting, change chimes to gentle chimes. The user could also change or undo any changes they did not desire, but this would allow for a complete reconfiguration of the vehicle to a certain characteristic set in response to a single, simple answer by a user.

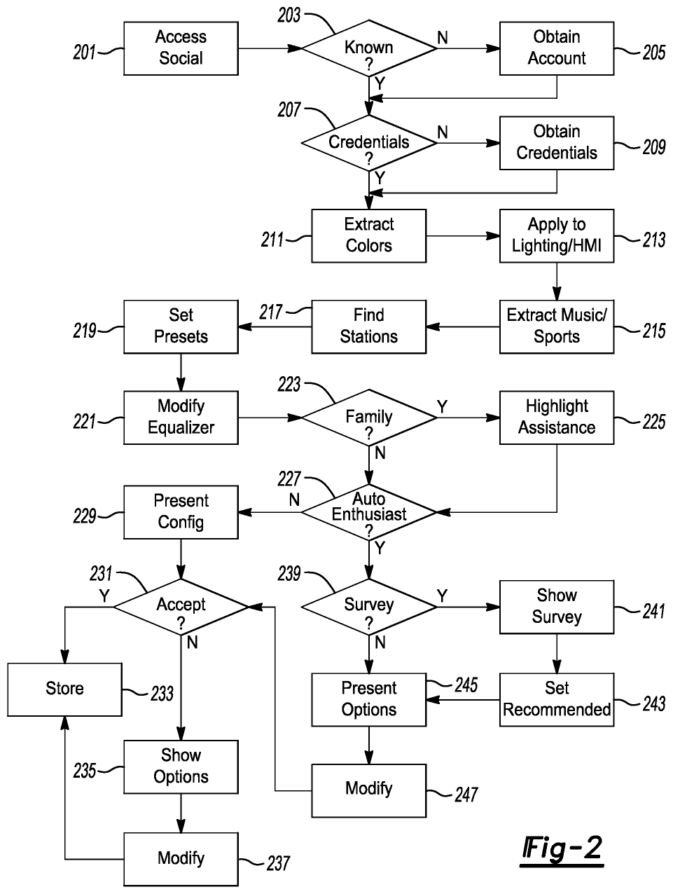

FIG. 2 shows an illustrative adaptation process leveraging driver data. This is an example of a process that can extract data from a user account that may also be otherwise unaffiliated with a vehicle (e.g., a social media account). Such accounts often contain a wealth of user data that most users will not mind being utilized expressly on their behalf to increase enjoyment of their vehicle. Of course, permission from a user may still be sought before leveraging such data, and may often be required in the form of credential provision, at a minimum.

In this example, the process attempts to access an account at 201, such as a social media account or other source of user data (e.g., web browsing history, vehicle rental history, club membership information, past driver profiles, age, family status, location, personal profile stored on a device or in the cloud, etc.). If there is at least one known account at 203, the process may move to determining whether credentials are known at 207. If there are no remaining accounts at 203, the process may ask the user at 205 if any additional accounts exist that the user would like to add, and/or obtain credentials for those and/or other known accounts at 209.

In this example, the process (by way of illustration only) extracts user favorite colors from the account at 211. This can include a simple retrieval of literal color preference indications, analysis of themes or user posts, analysis of user imagery, including both general colors favored in user posts as well as colors personally worn by identifiable images of the user. For some of the latter analysis, machine learning processes may be used in conjunction with a set of identified user imagery usable as training data to identify the user. More recent images may be more recognizable as the vehicle can use vehicle cameras to obtain (with user permission) current images and appearances of a user for training purposes. Then, the process can apply preferred colors to lighting and or a human-machine interface (HMI) or suggest application of a color set or possible color schemes the user may enjoy.

In a similar manner, the process may extract user preferences for music or sports at 215. Again, this is merely an example, but since radios are a high-usage element of a vehicle, it may be useful to know which stations and programs may be of interest to a user. This may also shed some insight into a user personality and assist in thematic development of other tuning aspects.

If there are discernable sports or music preferences, the process may set a list of recommended radio presets for the user at 219, which can be particularly useful if the user has just moved to a new area. The process may use programming guides, broadcast schedules and internet knowledge (e.g., reviews) to determine the correct stations at 217, which can also include satellite radio if the user is a subscriber or a free subscription is provided with a new vehicle.

A more complex setting may include modification of the vehicle equalizer at 219, which can be stored differently in conjunction with different station selections, so that the sound output is optimized for the type of broadcast occurring on the station.

If the user appears to have children (e.g., based on posts or analysis) at 223, the vehicle may highlight or even enable some desirable features at 225, such as internal vehicle communication, rear displays, rear climate control, etc.

If the user appears to be an automotive enthusiast at 227, the process may offer a special survey designed to provide deeper tuning of more complex vehicle systems at 239. If the user declines the survey at 245, the user may want to directly tune certain settings at 245. The vehicle may present the settings in a selectable manner and modify the settings at 247 in accordance with user instructions.

If the user elects the survey, the process may show a survey at 241 that inquires about driving preferences and may ask questions specifically designated for certain systems—e.g., does the user prefer a smooth or aggressive acceleration profile. Based on the answers, the system may set recommended parameters at 243 and show those parameter settings to the user at 245 before modifying the system at 247. Display of parameters and effect of certain settings may also include informational tooltips to better educate the user on what the change might cause.

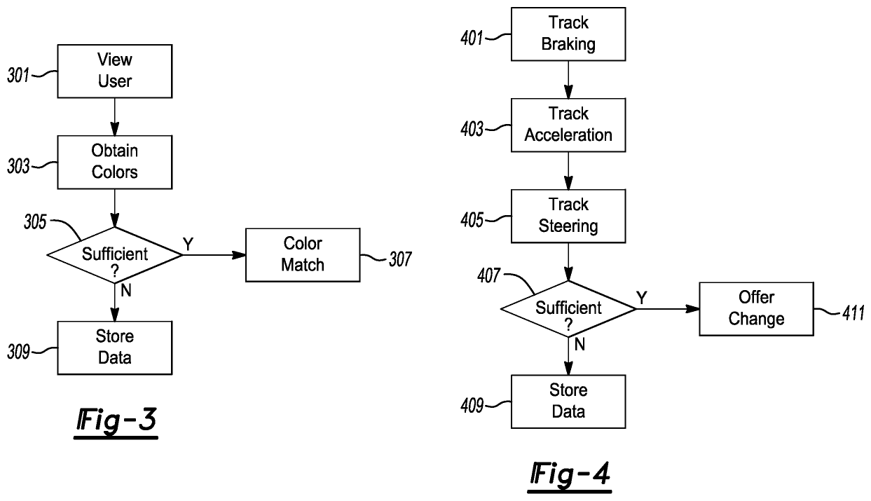

FIG. 3 shows one example of a particular illustrative adaptation. In this example, the vehicle process may attempt to color match a user outfit or certain color preferences. If the process is unsure of user color preferences, the process may use a camera to view a user at 301, such as an interior vehicle camera. This can provide color schemes at 303. The process may determine if sufficient data exits at 305.

Sufficient data may vary based on context. If the process is outfit matching, one instance of data should be sufficient in many cases, since the outfit will usually be visible and the effect may be a one-off for the day's outfit. In other instances, the process may be attempting to determine user favorite colors, and more than one observation may be needed. If the data is sufficient, the process may tune ambient lighting, entry lighting, approach lighting and/or HMI colors to match the preference of color or outfit at 307. Otherwise, the process may simply log the data at 309 to build a better profile.

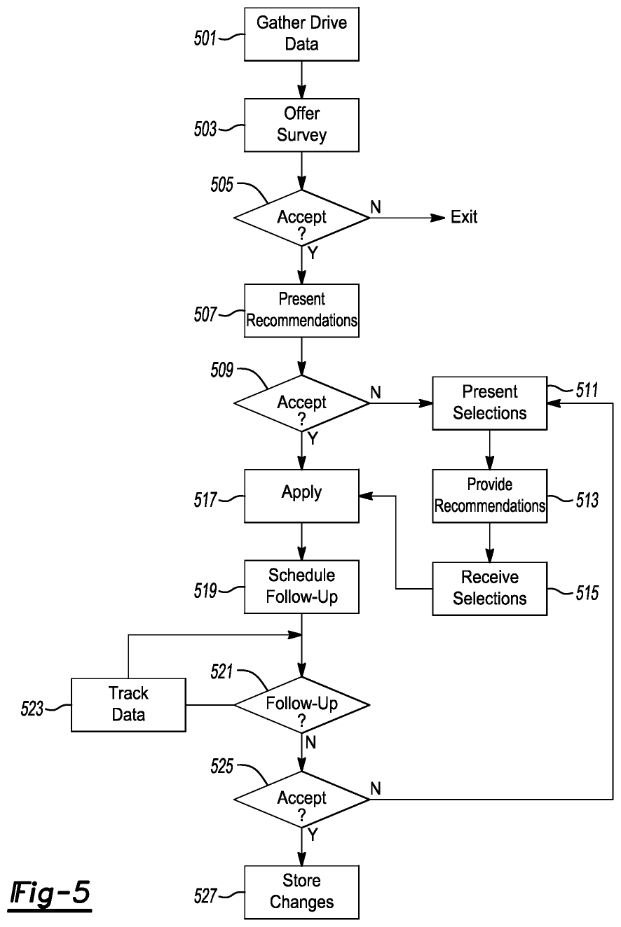

FIG. 4 shows an additional example of a particular illustrative adaptation. This is an example of vehicle control systems adjustment, in this instance, braking, acceleration and steering. In this example, the process may track the use of braking for some period of time at 401 (e.g., a drive, a week, a month, etc.). The process also tracks acceleration data 403 and steering data. This data can include aggressiveness, hard turning, hard braking, user pedal use (are the pedals set seemingly correctly for the user's leg length and feet), etc.

If there is sufficient data for at least one recommendation at 407, the process can offer to make a change. The offer may come with an explanation of the change, how the control feel may vary, etc. The user can be offered the change or can elect to have the vehicle implement the change automatically. At some point following a change, a survey may be presented to understand if the user wants to revert. There may also be an accessible menu with recent changes or an entire history of changes so a user can selectively revert any changes to a prior experience and setting if the change proves undesirable for some reason-that way the user may not have to wait for the vehicle to ask or implement a new change.

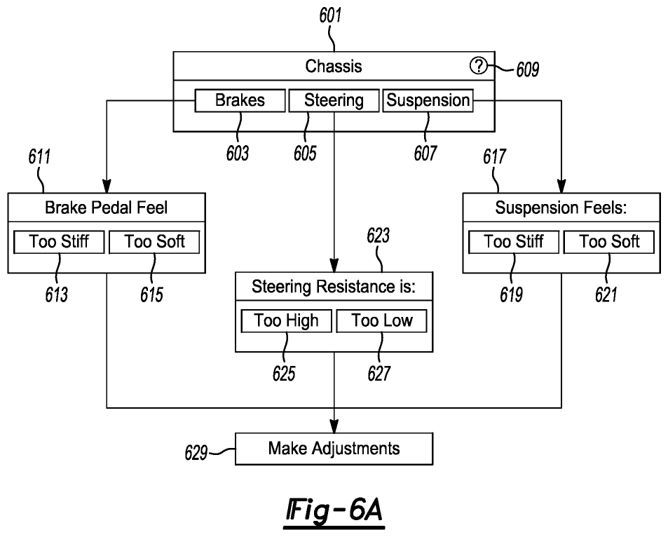

FIG. 5 shows an example of post-driving adaptive tuning. In this example, the process may gather drive data from a sequence of drives or any one particular drive at 501. If the data is from a single drive, the system may wait for a drive of over a certain time or distance, or that utilizes certain features more than a threshold number of times.

When the vehicle has gathered suitable drive data at 501, the process may offer the user a survey sat 503, to inquire about user preferences based on observation and better offer tuning of systems. While it is called a survey, the goal of this survey may be to elicit user-specific information, not general crowd preferences (although aggregate results could be used to determine the latter, as well, with user permission).

If the driver accepts at 505, the process may use a vehicle or mobile device display to present a list of recommendations at 507. This can include identification of systems being changed and setting changes, or can alternatively include a statement such as “a more sporty setting is recommended, would you like such changes implemented?” Users can also be provided with options to see more details about proposed changes or explanations of what changes will be accomplished, if desired.

If the user accepts at 509, the process may apply the proposed changes at 517. If the user declines the changes at 509, wholesale, then the user may be provided with a selectable list of options at 511 correlated to the recommended changes. This may include the recommended settings at 513 and any accompanying explanation as to what a change will likely do and/or why a given change was recommended. The process then receives user blessing or correction to any changes at 515.

Once a change has been made, the process may schedule a user follow up survey or questionnaire at 519. When the requisite time/mileage, etc. has passed at 521, the process may offer the follow up questionnaire, and otherwise track data at 523 if the set interval has not yet lapsed. If the user accepts the affect of the changes at 523, the process may store the changes on a more permanent basis at 525. Otherwise, the process may repeat questioning and selection of changes so a user can change or correct values that do not seem suitable.

In another example, the vehicle could, for example, present the results of monitoring driving such as “you had very efficient acceleration, would you like your pedal to be calibrated for continued efficiency?” If the driver answered “yes,” then the vehicle could change the mapping of a pedal to reduce powertrain output over pedal input range. Similar offers and changes could be made with respect to a variety of vehicle systems, wherein the vehicle may be the best source for understanding of how to tune its own systems to match a driver-preferred outcome.

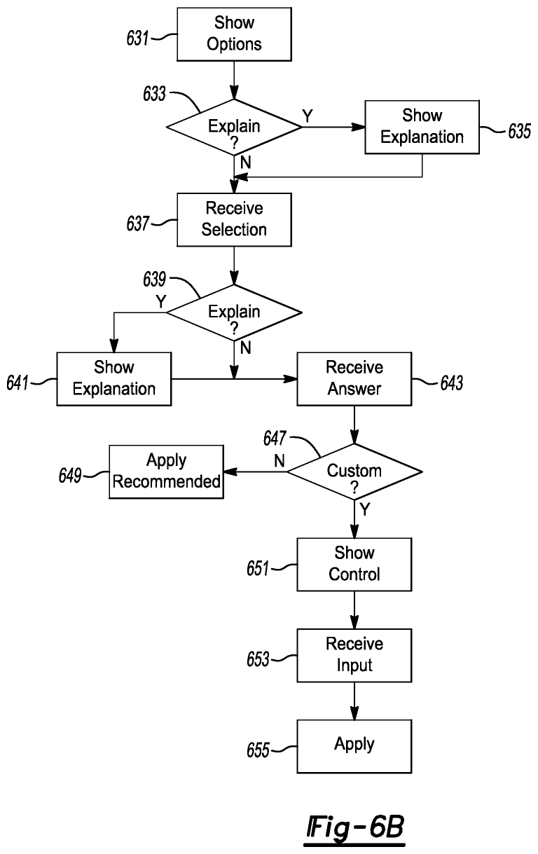

FIG. 6A shows an example of a menu for selective tuning instruction. The examples illustrated are representative of menus a user may be shown for selecting and tuning given options, even if the user is generally unsophisticated in automotive knowledge. Initially, the user may see a top level menu such as 501, which in this instance relates to the Chassis. If the user does not know what a Chassis is, or does not understand which of Brakes 603, Steering 605 or Suspension 607 to select, the user can select an icon 609 for more information and guidance. For example, selecting the icon could result in an explanation that the options to be changed were braking stiffness (how hard a user had to press to brake), steering resistance (how hard a user had to work to turn a wheel), or suspension stiffness (how sharply the vehicle conveys impacts to bumps and ditches). Explanations of stiff vs. soft for each category could also be provided, or those could be provided if a given category were selected and a second tooltip icon (not shown) were selected again.

For each option 603, 605, 607, the process may present a second menu—such as Brake Pedal Feel 611, which can lead to a choice between too stiff 613 versus too soft 615. Selection of one will result in an adjustment 629 towards the other and/or a recommendation to adjust towards the other. Whether the adjustment is automatic or responsive to a user selection of a level or control can be a matter of user preference. Similarly, suspension feel 617 may have options for too stiff 619 or too soft 621. Steering resistance 623 may have options for too high 625 or too low 627.

Similar categorical selection trees with very simplistic questions such as “too X or too Y” can easily allow a user to define what they perceive to be issues with their driving experience and let the vehicle 100 fine tune the driving experience to a user's comfort level.

FIG. 6B shows an illustrative process for selective tuning. In this example, the process shows the flow for providing options such as those discussed with respect to FIG. 6A. The process can receive input of a vehicle system or feature set to adjust and show the options at 631, which would be a display such as 601, for example. If there were a request for explanation at 633 (selection of tooltip icon 609), the process could show an explanation at 635, related to the displayed options, displayed categories and/or what selection of a given category might enable changing. For example, the tooltip for 601 may say (among other things)—“Suspension Stiffness allows for you to adjust how the vehicle feels when going over bumps and taking turns. Softer suspensions may give a gentler feel, but may also provide less road feel and make aggressive turning more difficult. Stiffer suspensions may convey road surface deviances more sharply, such as making a ride feel bumpier, but may also aid in better feeling the road and turning more aggressively.” That way, the user understands both the meaning of “stiff” and “soft” with regards to suspension, as well as can understand that selecting “too stiff” may reduce bumpiness but also require more gradual or less aggressive turning.

The process receives a selection of a menu option at 637 and then launches a sub-menu such as 617. Again, an explanation option may be provided at 639, which could just be the same suspension portion of the prior explanation (in this example) at 641 or could be a more detailed description of the variables affected by the chosen option. The user can answer the question at 643, and then be presented with an option to customize the control at 647 or simply accept a vehicle recommendation at 649.

If the user elects customization, the vehicle may show the control at 651 along with tuning settings. Selection of a particular setting at 653 may also cause a message based on an observed user habit—for example, if the user softens the suspension, the process may note that the user turns fairly aggressively, and may recommend either a stiffer setting or use of a turning coach which can help the user change a turn habit to better match the chosen setting. Since user preferences may not always accommodate a given setting (e.g., most people would likely prefer a very smooth ride but also like to be able to turn as aggressively as they would like in a situation), the user may need to understand the tradeoffs and either go with a balanced effect that provides a little of each solution or perhaps change a driving habit if one preference is given weight over another. A coach is a virtual assistant that can audibly and/or visually guide a user. In the turning example, the coach could guide the user to limit speed into the turn to a certain level based on the degree of turn and distance over which the turn needed to be accomplished, as well as provide recommendations for acceleration out of the turn to realign angular momentum coming out of the turn.

The driver can accept the recommendations and/or tune the element to their preference at 653, which the system can then apply at 655. If a coach is requested, the coach can appear at a designated location on a display.

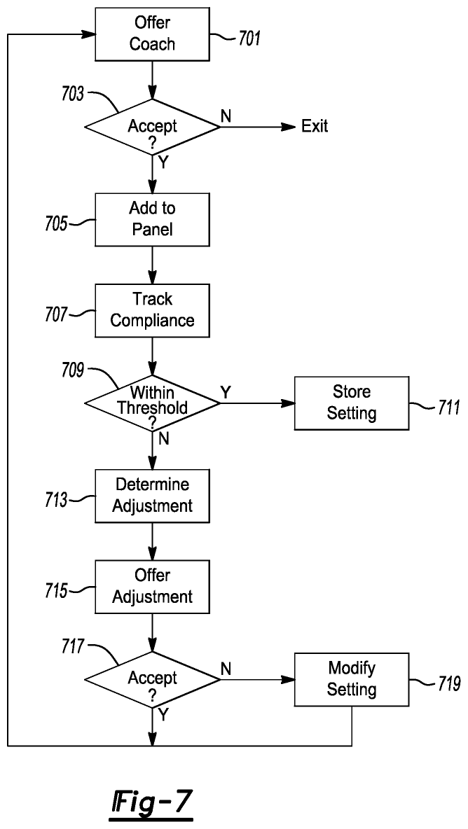

FIG. 7 shows an illustrative process for coaching and behavior tuning. This is an example of how a coach may be able to help a driver to adjust to a new setting. Driver preferences (e.g., smooth ride +sharp aggressive turning) may not always be compatible—i.e., there may not be a setting that completely satisfies both. The coach can help the driver adjust to a new setting by instructing guidance on how driver behavior can best match a new setting. The process may offer a coach for any number of settings at 701, which primarily will involve driver behavior coaching. If the driver accepts the coach at 703, the coach can be added to an instrument panel or heads up display at 705 in a manner that the driver can easily see it. There may also be a designated coaching zone so that various different coaching instructions can be presented as situationally needed during a drive—e.g., one for turning, one for acceleration on a straightaway, one for braking, etc. Coaching can be predefined as relevant for certain situations based on an aspect of vehicle performance affected by a change. For example, without limitation, a change to suspension could affect vehicle cornering and thus a coach could be provided during turns and have a pre-association with turns such that if a planned turn were known to be upcoming (based on, for example, signaling, route guidance, etc.), the coach could be presented (visually or audibly) at some point prior to the turn and through the duration of the turn. If the turn were not signaled, the coach could still have a predefined association with turning such that the coach was presented if the vehicle began a turn of more than a predefined degree.

The process also tracks how closely the user is able to willing to follow the instructions at 707. If, over a period of time, the behavior is within a threshold at 709, the process may store the new setting that elicited the coaching offer as a permanent setting at 711. That is, the user has adjusted and/or will continue to adjust behavior in a manner more suitable for the setting and so the setting is appropriate for storage.

If the user cannot fully comply or does not appear to want to comply based on behavior not matching guidance, the process may determine adjustments at 713 that may better match the user behavior. For example, using the suspension example, the user may have improved at turning more gently, but not sufficiently for the current suspension softness. The process can note this and offer the user a slightly stiffer suspension at 715. If the user accepts at 717, the setting can be modified and coaching can resume. Otherwise, the coaching may continue without reversion or changing of the setting.

By continually adapting vehicle settings to user preferences without actual direct necessary input from a user, at least in most instances, a vehicle can self-adjust to meet the observed preferences of a driver and increase satisfaction with overall vehicle usage. Moreover, countless unused or underappreciated features can be utilized and users can extract the full value from their vehicles. Efficiencies may be improved and users can either be better trained to manuver a particular vehicle when conflicting preferences emerge, or users can at least have the vehicle better configured to meet behavior that users cannot or will not change.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
one or more processors configured to:
enact a first change to a vehicle feature setting affecting vehicle performance in at least one aspect and store an association between a determined driver of the vehicle and the change;
monitor vehicle performance with respect to the at least one aspect for at least a predetermined period following enactment of the change;
report, using a vehicle display, the vehicle performance with respect to the at least one aspect following the monitoring;
responsive to the reporting, issue an inquiry with one or more predefined questions enquiring about the driver's changed experience in light of the change, the questions predefined for at least the at least one aspect;
determine whether a second change, responsive to the driver's answers to the inquiry, should be made to the vehicle feature setting, based on the driver's answers;
responsive to determining that the second change should be made, determine the nature of the second change;
enact the second change responsive to determining the nature of the second change; and
repeat the monitoring, reporting, inquiry, determination of whether to make and the nature of additional changes subsequent to the second change, and enactment of the additional changes until there is a determination that no additional changes should be made, to tune the vehicle feature setting to the driver.

2. The vehicle of claim 1, wherein the aspect includes acceleration.

3. The vehicle of claim 1, wherein the aspect includes braking.

4. The vehicle of claim 1, wherein the aspect includes handling.

5. The vehicle of claim 1, wherein the predetermined time period includes at least a predetermined duration of drive time, during which the driver is determined to be driving the vehicle.

6. The vehicle of claim 1, wherein the predetermined time period includes at least a predetermined distance of driving, during which the driver is determined to be driving the vehicle.

7. The vehicle of claim 1, wherein the predetermined time period is a next drive, following the change, of at least one of a predetermined time duration or distance, during which the driver is determined to be driving the vehicle.

8. The vehicle of claim 1, wherein the first change includes a driver selected value for the feature setting.

9. The vehicle of claim 1, wherein the first change includes a change recommended by the vehicle.

10. The vehicle of claim 1, wherein the one or more processors are configured to, in conjunction with enacting at least one of the first change, second change or additional changes:
offer a coach to instruct driver behavior in light of a respective change with which the offer is presented; and
responsive to acceptance of the offer, present at least one of a visual or audible coach, via an output of the vehicle, that instructs driver behavior during at least a vehicle manuver for which the at least one aspect is relevant based on a predefinition of relevance between the coach and the vehicle manuver.

11. The vehicle of claim 10, wherein the one or more processors are configured to:
determine whether the driver is behaving in accordance with guidance offered by the coach to within a predefined threshold of a goal pre-associated with the coach, based at least in part on driver behavior monitored for instances of presentation of the coach during the monitoring of the vehicle performance; and
responsive to the driver behaving within the predefined threshold, determine that at least one of the second or additional changes should not be made, to terminate or prevent the repetition of monitoring, reporting, inquiry, determination of whether to make and the nature of additional changes subsequent to the second change, and enactment of the additional changes.

12. The vehicle of claim 10, wherein the one or more processors are configured to:
determine whether the driver is behaving in accordance with guidance offered by the coach to within a predefined threshold of a goal pre-associated with the coach, based at least in part on driver behavior monitored for instances of presentation of the coach during the monitoring of the vehicle performance; and
responsive to the driver not behaving within the predefined threshold, revert whichever of the first change, second change or additional changes was made in conjunction with the offer of the coach.

13. A vehicle comprising:
one or more processors configured to:
access a predefined social media account of a determine driver and obtain at least one of a plurality of pictures or text postings saved by the driver on the social media account;
analyze the obtained pictures or text postings to determine at least one predicted driver preference; and
automatically adjust at least one vehicle feature setting in a manner predefined for at least one determined preference.

14. The vehicle of claim 13, wherein the predicted driver preference includes at least a color and wherein the adjustment includes adjusting a color of at least one of vehicle color-changeable interior or exterior lighting or vehicle display characteristics to include the color.

15. The vehicle of claim 13, wherein the predicted driver preference includes at least a music style and wherein the adjustment includes adjusting at least one preset radio station to include a station determined to play the music style.

16. The vehicle of claim 15, wherein the one or more processors are further configured to obtain at least one song identified by the driver on the social media account and to determine the music style based on the at least one song.

17. The vehicle of claim 13, wherein the predicted driver preference includes at least a sports team and wherein the adjustment includes adjusting at least one preset radio station to include a station determined to cover the sports team.

18. The vehicle of claim 17, wherein the adjustment further includes changing at least one of vehicle color-changeable interior or exterior lighting or a vehicle display characteristic to include one or more colors determined to be associated with the sports team.

19. The vehicle of claim 13, wherein the predicted driver preference includes at least a sports team and wherein the one or more processors are further configured to:
determine that a game involving the sports team is ongoing while the driver is in the vehicle;
determine at least one radio station covering the game;
automatically tune a radio of the vehicle to the at least one radio station.

20. A vehicle comprising:
one or more cameras capable of viewing a driver of the vehicle; and
one or more processors in communication with the one or more cameras and configured to:
image the driver using at least one of the one or more cameras;
determine, based on the imaging, at least one color associated with an outfit of the driver; and
automatically adjust at least one of vehicle color changeable interior or exterior lighting or a vehicle display characteristic to include the at least one color.
